(19) United States
(12) Patent Application Publication
(10) Pub. No.: US 2005/0282016 A1
(43) Pub. Date: Dec. 22, 2005

(54) Polyester-polyurethane composite structure

(76) Inventors: Joseph Ogonowski, Newport, MI (US); Calvin T. Peeler, Canton, MI (US); Theresa Howard, Canton, MI (US); Micheal C. May, Clawson, MI (US); James F. Turnbach, Troy, MI (US); Joseph Jibrail, Canton, GA (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/874,026

(22) Filed: Jun. 22, 2004

(51) Int. Cl. C08G 69/26

(52) U.S. Cl. 428/423.1

(57) ABSTRACT

A composite structure including a first layer, comprising a styrenated polyester, and a polyurethane layer is disclosed. The first layer is a show surface of the composite structure. The polyurethane layer is the reaction product of a resin component and a stochiometric excess of polyisocyanate relative to the polyol. The resin component includes a polyol having a propylene oxide cap of at least 80 percent by weight.

### FIELD OF THE INVENTION

The present invention generally relates to a composite structure including a first layer, which is a show surface of the composite structure, and a second layer. More specifically, the first layer includes a styrenated polyester and the second layer is a polyurethane layer. The composite structure is primarily utilized in the boating, automobile, swimming pool, and home industries, including the kitchen and bathroom industries.

### BACKGROUND OF THE INVENTION

Use of composite structures throughout the boating, automobile, swimming pool, and home industries is known in the art. As is known in the art, prior art composite structures include those having a first layer, or show surface, commonly referred to as a styrenated polyester gelcoat layer, and a second layer, commonly referred to as a styrenated polyester resin backing layer. The backing layer functions to provide support and durability to the complete composite article.

It is also known in the art that, during application of the first and second layers to a mold substrate, large quantities of styrene monomers, which are considered volatile organic compounds (VOCs), are emitted which is undesirable for environmental, health, and safety reasons. As a result of the quantities of styrene monomers associated with the composite structures of the prior art, the industry has sought to eliminate certain layers in the composite structures that do not include styrene.

In response to the need outlined above, the industry is moving toward composite structures that have the same first layer described above but a different second layer. This different second layer is a polyurethane backing layer. However, the composite articles of the prior art that already include a polyurethane backing layer as the second layer are deficient for various reasons.

Generally, the polyurethane backing layers of the prior art, when used in combination with a styrenated polyester gelcoat layer, “set-up” or react too quickly. For instance, when the polyurethane backing layer is applied to the first layer, i.e., to the styrenated polyester gelcoat layer, there is an exotherm that is generated which frequently causes off-gassing of the styrene monomers present in the first layer. It is important to incorporate certain polyols into polyurethane backing layer, specifically into a resin component of the polyurethane backing layer, to control this exotherm. The polyurethane backing layers of the prior art do not adequately control this exotherm. When this exotherm is uncontrolled, the polyurethane backing layer reacts too quickly, and the excessive off-gassing of the styrene monomers during this short reaction causes blisters in the first layer, i.e., in the show surface, of the composite structure. These blisters are undesirable. Overall, the polyurethane backing layers of the prior art have not, to date, been optimized for use with a styrenated polyester gelcoat layer such that the exotherm can be appropriately harnessed and blisters in the show surface of the complete composite structure can be adequately minimized.

When the polyurethane backing layer sets-up too quickly, cross-linking between the polyurethane backing layer and the styrenated polyester gelcoat layer, which has already been applied to the mold substrate, is also impacted. Specifically, adequate cross-linking between the polyurethane backing layer and the styrenated polyester gelcoat layer is unable to occur because the polyurethane backing layers sets up too quickly. Ultimately, the bond between the polyurethane backing layer and the styrenated polyester gelcoat layer is unacceptable because there is insufficient cross-linking between layers.

More specifically, the polyurethane backing layers of the prior art have not, to date, been optimized for use with styrenated polyester gelcoat layers by optimizing the particular polyols utilized in the resin component of the polyurethane backing layer. Instead, the prior art polyurethane backing layers incorporate polyols having excessively high ethylene oxide (EO) capping which tends to cause the polyurethane backing layer to set-up too quickly. As a result, the polyurethane backing layers of the prior art realize blisters and do not adequately cross-link with the styrenated polyester gelcoat layer.

The polyurethane backing layers of the prior art are also overly reliant on catalysts. That is, these polyurethane backing layers have not, to date, optimized the amount, if any, of catalyst present in a resin component of the polyurethane backing layers. As a result, there is increased blowing in the polyurethane backing layers of the prior art. Increase blowing leads to an open-celled cellular structure which negatively impacts the amount of support and durability the polyurethane backing layer provides to the composite structure. Instead, in the industries described above, it is most desirable if the polyurethane backing layer is of a compact cellular structure.

The composite structures of the prior art that combine a polyurethane backing layer with a styrenated polyester gelcoat layer are further deficient in that the ratio of the isocyanate-to resin component in the polyurethane backing layer is not optimized. More specifically, the isocyanate in the polyurethane backing layer is not present in excess relative to the resin component. As a result, the polyurethane backing layer sets-up too quickly the problems described above occur.

Due to the deficiencies in the composite structures of the prior art, including those described above, it is desirable to provide a novel and durable composite structure having a styrenated polyester gelcoat show surface backed by a polyurethane backing layer that reacts in a controlled manner such that blistering in the show surface is prevented and such that there is adequate time for cross-linking to occur between the show surface and the backing layer.

### SUMMARY OF THE INVENTION

A composite structure is disclosed. The composite structure of the subject invention includes a first layer and a polyurethane layer. The first layer comprises a styrenated polyester and is a show surface of the composite structure. The polyurethane layer comprises the reaction product of a resin component and a stoichiometric polyisocyanate relative to the resin component. More specifically, the resin component comprises a polyol, and the polyol comprises a propylene oxide cap of at least 80 percent by weight based on the total weight of the polyol.

The amount of propylene oxide capping of the polyol in the resin component of the polyurethane layer controls the rate at which the polyurethane layer “sets-up” or reacts. This controlled rate adequately harnesses an exotherm that is generated during the reaction of the polyurethane layer. As such, off-gassing of any styrene monomers present in the first layer is minimized and blistering in the first layer, which is the show surface of the composite structure, is prevented. The amount of propylene oxide capping also controls the rate at which the polyurethane layer reacts such that cross-linking between the polyurethane layer and the first layer, specifically with the styrenated polyester of the first layer, can occur.

The amount of catalyst and the amount of polyisocyanate in the resin component of the polyurethane layer have also been optimized such that the polyurethane layer reacts in a controlled manner to prevent blistering in the show surface, to optimize cross-linking between the show surface and the backing layer, and to produce a compact cellular structure in the polyurethane layer to maximize the support and durability that the polyurethane layer provides to the composite structure.

### DETAILED DESCRIPTION OF A PREFERRED EMBODIMENT

A composite structure is disclosed. The composite structure of the subject invention includes a first layer and a polyurethane. Ultimately, the first layer is a show surface of the composite structure. The first layer comprises a styrenated polyester, and the polyurethane layer comprises the reaction product of a resin component and a stoichiometric excess of polyisocyanate relative to the resin component. The resin component more specifically comprises a polyol, and this polyol comprises a propylene oxide (PO) cap of at least 80 percent by weight based on the total weight of the polyol.

The first layer and the polyurethane layer are applied to a mold substrate in an open-mold process to form the composite structure. In the open-mold process, the first layer is first applied to a surface of the mold substrate, and then the polyurethane layer is applied after the first layer without the mold substrate having to close upon itself to form the composite structure. The first layer and the polyurethane layer are then de-molded from the open mold substrate. After application of the first layer and the polyurethane layer, and also after the de-molding of the completed composite structure, the first layer is a top layer or show surface of the composite structure whereas the polyurethane layer is a support or backing layer to the first layer. The polyurethane layer functions to provide support and durability to the first layer of the completed composite structure.

The styrenated polyester of the first layer has a nominal styrene content of at least 28 percent. In one preferred embodiment, the nominal styrene content of the styrenated polyester is 42 percent. The styrenated polyester is formed from phthalic acid and an organic compound. The organic compound comprises a plurality of hydroxyl groups. The phthalic acid is most preferably isophthalic acid, and the organic compound is most preferably an alcohol. Available hydrogen atoms from the isophthalic acid are replaced with an organic group of the alcohol to form the polyester. One styrenated polyester suitable for use in the subject invention is commercially available as Vipel™ F737-FB Series Polyester Resin (formerly E737-FBL) from AOC Resins of Collierville, Tenn.

As described above, the resin component comprises the polyol. The resin component may comprise just the one polyol. As described above, the polyol need only include a PO cap of at least 80 percent by weight based on the total weight of the polyol. However, it is most preferred that the polyol include a PO cap of 100 percent by weight based on the total weight of the polyol. That is, although the polyol may include some percentage of an ethylene oxide (EO) cap, it is most preferred that the percentage of EO cap, based on the total weight of the polyol, is zero.

Other physical properties of the polyol of the resin component include a hydroxyl number and a nominal functionality. The polyol has a hydroxyl number of at least 35 mg KOH/gm. More preferably, the polyol has a hydroxyl number of from 200 to 810 mg KOH/gm. In the most preferred embodiments of the subject invention, the polyol has a hydroxyl number of from 200 to 500 mg KOH/gm. The polyol has a nominal functionality of at least 2.5. More specifically, the preferred polyol has a nominal functionality of from about 2.59 to about 4.00. By nominal functionality, it is meant that the functionality is based upon the functionality of the initiator molecule, rather than the actual functionality of the polyol after manufacture.

Although polyether polyols are preferred, the polyol may be either a polyether polyol or a polyester polyol. The polyol is present in the resin component in an amount from 55 to 99, more preferably from 66 to 98, parts by weight based on 100 parts by weight of the resin component. If a plurality of polyols is present in the resin component, as described below, then the plurality is present in the same amount. The polyol is formed from an initiator compound. Preferably, the initiator compound comprises at least one of glycerin, trimethylolpropane, pentaerythritol, propylene glycol, and ethylenediamine. More generally, the initiator compound comprises low molecular weight di-, tri-, and poly-functional alcohols or polyamines, including primary and secondary amines. Other, more specific, initiator compounds include, but are not limited to, toluenediamine and dipropylene glycol so long as the nominal functionality properties for the polyol are satisfied so long as described above.

Suitable polyols for the resin component include, but are not limited to, all phthalic anhydride-initiated polyester polyols, aromatic amine-initiated polyols, aliphatic amine-initiated polyols, polyoxyalkylene polyether polyols, polythioether polyols, polyester amides and polyacetals containing hydroxyl groups, aliphatic polycarbonates containing hydroxyl groups, amine terminated polyoxyalkylene polyethers, polyester polyols, other polyoxyalkylene polyether polyols, and graft dispersion polyols, and combinations thereof.

Included among the polyoxyalkylene polyether polyols are polyoxyethylene polyols, polyoxypropylene polyols, polyoxybutylene polyols, polytetramethylene polyols, and block copolymers, for example combinations of polyoxypropylene and polyoxyethylene poly-1,2-oxybutylene and polyoxyethylene polyols, poly-1,4-tetramethylene and polyoxyethylene polyols, and copolymer polyols prepared from blends or sequential addition of two or more alkylene oxides. The polyoxyalkylene polyether polyols may be prepared by any known process such as, for example, the process disclosed by Wurtz in 1859 and Encyclopedia of Chemical Technology, Vol. 7, pp. 257-262, published by Interscience Publishers, Inc. (1951) or in U.S. Pat. No. 1,922,459. The alkylene oxides may be added to the initiator compound, individually, sequentially one after the other to form blocks, or in mixture to form a heteric polyether. The polyoxyalkylene polyether polyols may have either primary or secondary hydroxyl groups.

The polyoxyalkylene polyether polyols may be aromatic amine-initiated or aliphatic amine-initiated polyoxyalkylene polyether polyols. The amine-initiated polyols may be polyether polyols terminated with a secondary hydroxyl group through addition of, for example, propylene oxide as the terminal block. It is preferred that the amine-initiated polyols contain 50 weight percent or more, and up to 100 weight percent, of secondary hydroxyl group forming alkylene oxides, such as polyoxypropylene groups, based on the weight of all oxyalkylene groups. This amount can be achieved by adding 50 weight percent or more of the secondary hydroxyl group forming alkylene oxides to the initiator molecule in the course of manufacturing the polyol.

As described above, suitable initiator compounds for the polyol include primary or secondary amines. These would include, for aromatic amine-initiated polyether polyols, the aromatic amines such as aniline, N-alkylphenylene-diamines, 2,4′-2,2′ and 4,4′-methylenedianiline, 2,6- or 2,4-toluenediamine, vicinal toluenediamines, o-chloro-aniline, p-aminoaniline, 1,5-diaminonaphthalene, methylene dianiline, the various condensation products of aniline and formaldehyde, and the isomeric diaminotoluenes, with preference given to vicinal toluenediamines.

For aliphatic amine-initiated polyols, any aliphatic amine, whether branched or unbranched, substituted or unsubstituted, saturated or unsaturated, may be used. These would include, as examples, mono-, di-, and trialkanolamines, such as monoethanolamine, methylamine, triisopropanolamine; and polyamines such as ethylene diamine, propylene diamine, diethylenetriamine; or 1,3-diaminopropane, 1,3-diaminobutane, and 1,4-diaminobutane. Preferable aliphatic amines include any of the diamines and triamines, most preferably, the diamines.

The polyoxyalkylene polyether polyols may generally be prepared by polymerizing alkylene oxides with polyhydric amines. Any suitable alkylenes oxide may be used such as ethylene oxide, propylene oxide, butylene oxide, amylene oxide, and combinations of these oxides so long as the polyol, after preparation, comprises the propylene oxide cap of at least 80 percent by weight based on the total weight of said polyol. The polyoxyalkylene polyether polyols may be prepared from other starting materials such as tetrahydrofuran and alkylene oxide-tetrahydrofuran mixtures; epihalohydrins such as epichlorohydrin; as well as aralkylene oxides such as styrene oxide.

Also suitable are polymer modified polyols, in particular, the so-called graft polyols. Graft polyols are well known to the art and are prepared by the in situ polymerization of one or more vinyl monomers, preferably acrylonitrile and styrene, in the presence of a polyether polyol, particularly polyols containing a minor amount of natural or induced unsaturation. Methods of preparing such graft polyols may be found in columns 1-5 and in the Examples of U.S. Pat. No. 3,652,639; in columns 1-6 and in the Examples of U.S. Pat. No. 3,823,201; in columns 2-8 and in the Examples of U.S. Pat. No. 4.690.956: and in U.S. Pat. No. 4,524,157; all of which patents are herein incorporated by reference.

Non-graft polymer modified polyols are also suitable, for example, as those prepared by the reaction of a polyisocyanate with an alkanolamine in the presence of a polyether polyol as taught by U.S. Pat. Nos. 4,293,470; 4,296,213; and 4,374,209; dispersions of polyisocyanurates containing pendant urea groups as taught by U.S. Pat. No. 4,386,167; and polyisocyanurate dispersions also containing biuret linkages as taught by U.S. Pat. No. 4,359,541. Other polymer modified polyols may be prepared by the in situ size reduction of polymers until the particle size is less than 20 mm, preferably less than 10 mm.

Preferably, however, the resin component includes a plurality of polyols. If the resin component includes a plurality of polyols, then each polyol of the plurality has a hydroxyl number of at least 35 mg KOH/gm and a nominal functionality of at least 2.5. Furthermore, an average hydroxyl number of said polyols in said plurality is at least 310 mg KOH/gm. Therefore, individual polyols within the plurality may fall below this average hydroxyl number, so long as the average is at least 310 mg KOH/gm.

In one embodiment of the subject invention, the plurality of polyols includes a pentaerythritol and propylene glycol initiated polyether polyol, referred to as a first polyol for descriptive purposes, having a hydroxyl number of from 400 to 500 mg KOH/gm and a nominal functionality of from 3 to 4, and a trimethylolpropane initiated polyether polyol, referred to as a second polyol for descriptive purposes, having a hydroxyl number of from 200 to 300 mg KOH/gm and a nominal functionality of from 2.3 to 3.5. Preferably, in this blend of polyols, each polyol includes the PO cap of 100 percent by weight based on the total weight of the polyol. One suitable first polyol is commercially available as Pluracol® PEP 550 from BASF Corporation, Wyandotte, Mich. One suitable second polyol is commercially available as Pluracol® TP 740 from BASF Corporation, Wyandotte, Mich.

In another embodiment of the subject invention, the plurality of polyols includes a glycerin initiated polyether polyol, referred to as a third polyol for descriptive purposes, having a hydroxyl number of from 350 to 450 mg KOH/gm and a nominal functionality of from 2.5 to 3.5, and a glycerin initiated polyether polyol, referred to as a fourth polyol for descriptive purposes, having a hydroxyl number of from 180 to 280 mg KOH/gm and a nominal functionality of from 2.5 to 3.5. Preferably, in this blend of polyols, each polyol includes the PO cap of 100 percent by weight based on the total weight of the polyol. One suitable third polyol is commercially available as Pluracol® GP430R from BASF Corporation, Wyandotte, Mich. One suitable fourth polyol is commercially available as Pluracol® GP730 from BASF Corporation, Wyandotte, Mich.

In yet a further embodiment of the subject invention, the plurality of polyols includes an ethylenediamine initiated polyether polyol, referred to as a fifth polyol for descriptive purposes, having a hydroxyl number of from 710 to 810 mg KOH/gm and a nominal functionality of from 3.5 TO 4.5, and a trimethylolpropane initiated polyether polyol, referred to as a sixth polyol for descriptive purposes, having a hydroxyl number of from 20 to 100 mg KOH/gm and a nominal functionality of from 2.0 to 3.0. One suitable fifth polyol is commercially available as Quadrol® Specialty Polyol from BASF Corporation, Wyandotte, Mich. One suitable sixth polyol is commercially available as Pluracol® 538 from BASF Corporation, Wyandotte, Mich.

In addition to the polyol, or polyols, the resin component may further comprise the reaction product of a catalyst. It is to be understood that the catalyst is not required for reaction between the polyol of the resin component and the polyisocyanate. However, if the catalyst is included, the catalyst comprises at least one of an amine-based catalyst and a tin-based catalyst, and is present in the resin component in an amount from 0.01 to 0.04 percent by weight based on the total weight of the resin component. General examples of amine- and tin-based catalysts are included below.

Preferred catalysts include, but are not limited triethylenediamine (TEDA), 1-methyl imidazole (NIMA), and dimethylbis[(1-oxoneodecyl)oxy]-stannane, which is also known as dimethyl tin dilaurate. (Fomrez UL-28). TEDA is commercially available as DABCO 33-LV® from Air Products and Chemicals, Inc., and dimethyl tin dilaurate is commercially available as Fomrez® UL-28 from Witco. The most preferred catalyst is NIMA.

General examples of suitable catalysts include organometallic catalysts, preferably organotin catalysts, although it is possible to employ metals such as lead, titanium, copper, mercury, cobalt, nickel, iron, vanadium, antimony, and manganese. Suitable organometallic catalysts, exemplified here by tin as the metal, are represented by the formula: RₙSN[X—R¹-y]₂, wherein R is a C₁-C₈ alkyl or aryl group, R¹ is a C₀-C₁₈ methylene group optionally substituted or branched with a C₁-C₄ alkyl group, Y is hydrogen or a hydroxyl group, preferably hydrogen, X is methylene, an —S—, an —SR²COO—, —SOOC—, an -0₃S—, or an —OOC— group wherein R² is a C₁-C₄ alkyl, n is 0 or 2, provided that R¹ is C₀ only when X is a methylene group.

Specific examples are tin (II) acetate, tin (II) octanoate, tin (II) ethylhexanoate and tin (II) laurate; and dialkyl (1-8C) tin (IV) salts of organic carboxylic acids having 1-32 carbon atoms, preferably 1-20 carbon atoms, e.g., diethyltin diacetate, dibutyltin diacetate, dibutyltin diacetate, dibutyltin dilaurate, dibutyltin maleate, dihexyltin diacetate, and dioctyltin diacetate. Other suitable organotin catalysts are organotin alkoxides and mono or polyalkyl (1-8C) tin (IV) salts of inorganic compounds such as butyltin trichloride, dimethyl- and diethyl- and dibutyl- and dioctyl- and diphenyl- tin oxide, dibutyltin dibutoxide, di(2-ethylhexyl) tin oxide, dibutyltin dichloride, and dioctyltin dioxide. Further suitable catalysts are tin catalysts with tin-sulfur bonds which are resistant to hydrolysis, such as dialkyl (1-20C) tin dimercaptides, including dimethyl-, dibutyl-, and dioctyl- tin dimercaptides.

As for catalysis of the reaction between the polyol in the resin component and the polyisocyanate, in addition to the catalysts already identified above, tertiary amines may also be used to promote urethane linkage formation in the polyurethane layer. In addition to TEDA, these amines include triethylamine, 3-methoxypropyldimethylamine, tributylamine, dimethylbenzylamine, N-methyl-, N-ethyl-and N-cyclohexylmorpholine, N,N,N′,N′-tetramethylethylenediamine, N,N,N′,N′-tetramethylbutanediamine or -hexanediamine, N,N,N′-trimethyl isopropyl propylenediamine, pentamethyldiethylenetriamine, tetramethyldiaminoethyl ether, bis(dimethylaminopropyl)urea, dimethylpiperazine, 1-methyl4-dimethylaminoethyl-piperazine, 1,2-dimethylimidazole, 1-azabicylo[3.3.0]octane and preferably 1,4-diazabicylo[2.2.2]octane, and alkanolamine compounds, such as triethanolamine, triisopropanolamine, N-methyl- and N-ethyldiethanolamine and dimethylethanolamine.

The resin component may also further comprise an additive or additives. If included, the additive is selected from the group consisting of surfactants, flame retardants, fillers, water scavengers, anti-foam agents, surfactants, UV performance enhancers, hindered amine light stabilizers, pigments, thixotropic agents (both reactive and non-reactive), chain extenders, and combinations thereof. Other suitable additives include, but are not limited to, cell regulators, hydrolysis-protection agents, fungistatic and bacteriostatic substances, dispersing agents, adhesion promoters, and appearance enhancing agents. Each of these additives serves a specific function, or functions, within the resin component that are known to those skilled in the art. As one example, a pigment, such as a white pigment, either raw or in a dispersion form, may be used to impart a color on the composite article.

Further details on the other conventional assistants and additives mentioned above can be obtained from the specialist literature, for example, from the monograph by J. H. Saunders and K. C. Frisch, High Polymers, Volume XVI, Polyurethanes, Parts 1 and 2, Interscience Publishers 1962 and 1964, respectively, or Kunststoff-Handbuch, Polyurethane, Volume VII, Carl-Hanser-Verlag, Munich, Vienna, 1st and 2nd Editions, 1966 and 1983; incorporated herein by reference.

The resin component may also further include an indicating dye. The indicating dye indicates thorough mixing between the polyisocyanate and the resin component. If the indicating dye is present in the resin component, then the resin component preferably includes from 0.01 to 1.0, more preferably from 0.02-0.05, percent by weight based on the total weight of the resin component.

In a preferred embodiment, the original color of the indicating dye is blue. If after application of and reaction between the polyisocyanate and the resin component, the original blue color is maintained, then thorough mixing between the two components has not occurred. On the other hand, if after application of and reaction between the polyisocyanate and the resin component, the original blue color shifts to a greenish color, then thorough mixing between the polyisocyanate and the resin component has occurred. One suitable indicating agent is commercially available as Reactint® Blue 17AB from Milliken Chemical, Division of Milliken & Co., Spartanburg, S.C. This indicating agent, and others like it, are set forth in U.S Pat. No. 4,775,748, the disclosure of which is incorporated herein by reference in its entirety.

As initially described above, the resin component reacts with the stoichiometric excess of polyisocyanate, relative to the resin component, to form the polyurethane layer. The polyurethane layer has urethane linkages. In a preferred embodiment of the subject invention, the polyisocyanate is further defined as polymeric diphenylmethane diisocyanate (PMDI). It is to be understood that the polyisocyanate may also be a pre-polymer. That is, the polyisocyanate may be a polyisocyanate initiated pre-polymer including a polyisocyanate, such as PMDI, in a stochiometric excess and a polyol resin component. Although not required, this polyol resin component may be the same as the polyol or polyols described above. The stoichiometric excess of polyisocyanate may comprise a plurality of polyisocyanates. That is, a blend of at least two polyisocyanates may be utilized for reaction with the resin component to forth the polyurethane layer.

The polyisocyanate has a nominal isocyanate functionality of from 2 to 3. Such functionalities provide for a greater cross-linking density which improves the overall dimensional stability of the composite structure. If the polyurethane layer incorporates a plurality of polyisocyanates, then although the nominal isocyanate functionality of any particular isocyanate may fall above or below the range of from 2 to 3, the average nominal isocyanate functionality remains from 2 to 3. The polyisocyanate utilized to form the polyurethane layer of the subject invention has a NCO content of from 20 to 35, more preferably from 23 to 32, percent by weight based on the total weight of the polyisocyanate.

The stoichiometric excess of polyisocyanate is satisfied, upon application, because the volume ratio of the polyisocyanate to the resin component is from 1.1:1 to 3:1. More preferably, this volume ratio is from 1.2:1 to 2:1. In other terms known in the art, the polyisocyanate and the resin component are reacted in such amounts that the isocyanate index, defined as the number of equivalents of NCO groups divided by the total number of isocyanate reactive hydrogen atom equivalents multiplied by 100, ranges from about 80 to less than about 150, preferably from about 90 to 115.

Preferred polyisocyanates include, but are not limited to, Lupranate® M20S, Lupranate® MM103, Lupranate® MP102, and Elastoflex® R23000. All of these polyisocyanates are commercially available from BASF Corporation, Wyandotte, Mich.

Other suitable polyisocyanates include, but are not limited to, conventional aliphatic, cycloaliphatic, araliphatic and aromatic isocyanates. Specific examples include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′- 2,2′-, and 2,4′-dicyclohexylmethane diisocyanate as well as the corresponding isomeric mixtures and aromatic diisocyanates and polyisocyanates such as 2,4- and 2,6-toluene diisocyanate and the corresponding isomeric mixtures 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylenepolymethylene polyisocyanates (crude MDI), as well as mixtures of crude MDI and toluene diisocyanates. The organic di- and polyisocyanates can be used individually or in the form of mixtures.

Additionally, so-called modified multivalent isocyanates, i.e., products obtained by the partial chemical reaction of organic diisocyanates and/or polyisocyanates may be used. Examples include diisocyanates and/or polyisocyanates containing ester groups, urea groups, biuret groups, allophanate groups, carbodiimide groups, isocyanurate groups, and/or urethane groups.

More specific examples of polyisocyanates and isocyanate pre-polymers include aromatic, polyisocyanates containing urethane groups and having an NCO content of from 35 to 20 weight percent, preferably from 32 to 23 weight percent, based on the total weight, e.g. with low molecular weight diols, triols, dialkylene glycols, trialkylene glycols, or polyoxyalkylene glycols with a molecular weight of up to 6000; modified 4,4′-diphenylmethane diisocyanate or 2,4- and 2,6-toluene diisocyanate, where examples of di- and polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or -triols. Prepolymers containing NCO groups and produced from the polyester polyols and/or preferably polyether polyols described herein are also suitable. 4,4′-diphenylmethane diisocyanate, mixtures of 2,4′- and 4,4′-diphenylmethane diisocyanate, and 2,4,- and/or 2,6-toluene diisocyanates are also suitable.

Furthermore, liquid polyisocyanates containing carbodiimide groups are also suitable, e.g. those based on 4,4′- and 2,4′- and/or 2,2′-diphenylmethane diisocyanate and/or 2,4′- and/or 2,6-toluene diisocyanate. The modified polyisocyanates may optionally be mixed together or mixed with unmodified organic polyisocyanates such as 2,4′- and 4,4′-diphenylmethane diisocyanate, polymeric MDI, 2,4′- and/or 2,6-toluene diisocyanate.

The completed composite structure of the subject invention has a heat distortion temperature of from 175° F. to 300° F., more preferably from 190° F. to 225° F., and most preferably from 190° F. to 210° F. Furthermore, the composite structure of the subject invention has a gel time of from 3 to 20 minutes. As understood by those skilled in the art, the gel time can be used to evaluate the amount of exotherm produced by the polyurethane layer. The quicker the gel time, the more the exotherm produced by the polyurethane layer, and the slower the gel time, the less the exotherm produced by the polyurethane layer.

The following examples, illustrating the composition of the first layer and the polyurethane layer are intended to illustrate and not to limit the invention. The amounts set forth in these examples are by weight, unless otherwise indicated.

| | | Ex. | Ex. | Ex. | Ex. | Ex. |
|---|---|---|---|---|---|---|
| Layer | Component | 1 | 2 | 3 | 4 | 5 |
| First | Styrenated | 100.00 | 100.00 | 100.00 | 100.00 | 100.00 |
| Layer | Polyester A | | | | | |
| | Total | 100.00 | 100.00 | 100.00 | 100.00 | 100.00 |
| Poly- | Polyol A | 89.80 | 87.12 | 87.12 | 85.29 | 47.38 |
| urethane | | | | | | |
| Layer | | | | | | |
| | Polyol B | 9.14 | 8.86 | 8.86 | 8.68 | — |
| | Polyol C | — | — | — | — | 30.00 |
| | Polyol D | — | — | — | — | — |
| | Polyol E | — | — | — | — | — |
| | Polyol F | — | — | — | — | — |
| | Polyol G | — | — | — | — | — |
| | Catalyst A | 0.04 | 0.02 | — | 0.02 | — |
| | Catalyst B | — | — | — | 0.10 | — |
| | Catalyst C | — | — | — | — | 0.10 |
| | Indicating | 0.02 | — | — | — | 0.02 |
| | Dye A | | | | | |
| | Additive A | 1.00 | 1.00 | 1.00 | 0.98 | 1.50 |
| | Additive B | — | 3.00 | 3.00 | 2.94 | — |
| | Additive C | — | — | — | 1.50 | — |
| | Additive D | — | — | — | 0.50 | — |
| | Additive E | — | — | — | — | 14.00 |
| | Additive F | — | — | — | — | 7.00 |
| | Additive G | — | — | — | — | — |
| | Additive H | — | — | — | — | — |
| | Additive I | — | — | — | — | — |
| | Additive J | — | — | — | — | — |
| | Additive K | — | — | — | — | — |
| | Additive L | — | — | — | — | — |
| | Total | 100.00 | 100.00 | 99.98 | 100.01 | 100.00 |
| | Isocyanate A | 50.00 | 50.00 | — | 50.00 | — |
| | Isocyanate B | 50.00 | 50.00 | 135.01 | 50.00 | — |
| | Isocyanate C | — | — | 104.80 | — | — |
| | Isocyanate D | — | — | — | — | 118.07 |
| | Total | 100.00 | 100.00 | 239.81 | 100.00 | 118.07 |

| | | | | | |
|---|---|---|---|---|---|
| Mix Ratio @ 100 Index | 70/82.7 | 100/ | 100/ | 100/114 | 100/ |
| | | 113.8 | 113.8 | | 109.3 |
| Volumetric Ratio (R:T) | 1:1 | 1:1 | 1:1 | 1:1 | 1:1 |

| | | Ex. | Ex. | Ex. | Ex. |
|---|---|---|---|---|---|
| Layer | Component | 6 | 7 | 8 | 9 |
| | | 70033R / | 70034R / | John P. | John P. |
| | | 71071T | 71071T | #1 | #2 |
| First | Styrenated | 100.00 | 100.00 | 100.00 | 100.00 |
| Layer | Polyester A | | | | |
| | Total | 100.00 | 100.00 | 100.00 | 100.00 |
| Polyurethane | Polyol A | — | — | — | — |
| Layer | | | | | |
| | Polyol B | — | — | — | — |
| | Polyol C | — | — | — | — |
| | Polyol D | 54.40 | 53.60 | — | — |
| | Polyol E | 13.00 | 13.00 | — | — |
| | Polyol F | — | — | 60.99 | 82.12 |
| | Polyol G | — | — | 28.33 | 8.00 |
| | Catalyst A | — | — | — | — |
| | Catalyst B | — | — | 0.15 | 0.15 |
| | Catalyst C | — | — | — | — |
| | Indicating | — | 0.05 | — | — |
| | Dye A | | | | |
| | Additive A | 3.00 | 3.00 | 1.00 | 1.00 |
| | Additive B | 3.00 | — | 5.43 | 5.43 |
| | Additive C | 1.25 | 1.25 | 1.00 | — |
| | Additive D | 1.25 | — | — | — |
| | Additive E | 14.00 | 14.00 | — | — |
| | Additive F | — | — | — | — |
| | Additive G | 5.00 | 5.00 | — | — |
| | Additive H | 5.00 | 5.00 | — | — |
| | Additive I | — | 5.00 | — | — |
| | Additive J | 0.10 | 0.10 | — | — |
| | Additive K | — | — | 0.10 | 0.30 |
| | Additive L | — | — | 3.00 | 3.00 |
| | Total | 100.00 | 100.00 | 100.00 | 100.00 |
| | Isocyanate A | 100.00 | 100.00 | 75.0 | 95.5 |
| | R23000 | | | | |
| | Isocyanate B | — | — | — | — |
| | MP102 | | | | |
| | Isocyanate C | — | — | — | — |
| | MM103 | | | | |
| | Isocyanate D | — | — | — | — |
| | M20S | | | | |
| | Total | 100.00 | 100.00 | 75.0 | 95.5 |

| | | | | |
|---|---|---|---|---|
| Mix Ratio @ 100 Index | 100/68.2 | 100/70 | 100/75 | 100/95.5 |
| Volumetric Ratio (R:T) | 1.5:1 | 1.5:1 | 1.5:1 | 1:1 |

Styrenated Polester A is a styrenated polyester commercially available as Vipel™ F737-FB Series Polyester Resin (formerly) E737-FBL) from AOC Resins of Collierville, Tenn.

Polyol A is a pentaerythritol and propylene glycol initiated polyether polyol having a hydroxyl number of from 400 to 500 mg KOH/gm and a nominal functionality of from 3 to 4.

Polyol B is a trimethylolpropane initiated polyether polyol having a hydroxyl number of from 200 to 300 mg KOH/gm and a nominal functionality of from 2.3 to 3.5.

Polyol C is a glycerin initiated polyether polyol having a hydroxyl number of from 30 to 40 mg KOH/gm and a nominal functionality of from 2.0 to 3.0.

Polyol D is a trimethylolpropane initiated polyether polyol having a hydroxyl number of from 20 to 100 mg KOH/gm and a nominal functionality of from 2.0 to 3.0.

Polyol E is an ethylenediamine initiated polyether polyol having a hydroxyl number of from 710 to 810 mg KOH/gm and a nominal functionality of from 3.5 to 4.5.

Polyol F is a glycerin initiated polyether polyol having a hydroxyl number of from 350 to 450 mg KOH/gm and a nominal functionality of from 2.5 to 3.5.

Polyol G is a glycerin initiated polyether polyol having a hydroxyl number of from 180 to 280 mg KOH/gm and a nominal functionality of from 2.5 to 3.5.

Catalyst A is a dimethyl tin dilaurate catalyst.

Catalyst B is a 1-methyl imidazole catalyst.

Catalyst C is a triethylenediamine catalyst.

Indicating Dye A is a blue dye commercially available as Reactint® Blue 17AB from Milliken Chemical, Division of Milliken & Co., Spartanburg, S.C.

Additive A is a 3A molecular sieve water scavenger.

Additive B is a dispersion comprising white pigment.

Additive C is a diethyltoluenediamine reactive thixotrope.

Additive D is a solution of modified urea functioning as a non-reactive thixotrope that is commercially available from BYK-Chemie as BYK® 410.

Additive E is a diethylene glycol chain extender.

Additive F is a 1,4-butanediol chain extender.

Additive G is a tetrabromo phthalate diol, commonly referred to as PHT4 Diol.

Additive H is tri(2-chloroisopropyl)phosphate flame retardant.

Additive I is castor oil.

Additive J is BYK 610 or BYK 550 anti-foam agent.

Additive K is BYK 066N anti-foam agent.

Additive L is a hydrophobic fumed silica functioning as a non-reactive thixotrope.

Isocyanate A is PMDI, a polymethylene polyphenylpolyisocyanate, with a functionality of approximately 2.7 and a NCO content for 31.5 percent by weight.

Isocyanate B is a liquid modified pure diphenylmethane diisocyanate with a NCO content of 23.0 percent by weight.

Isocyanate C is a liquid carbodiimide modified 4,4′-diphenylmethane diisocyanate with a NCO content of 29.5 percent by weight.

Isocyanate D is a PMDI, a polymethylene polyphenylpolyisocyanate, with a functionality of approximately 2.7 and a NCO content for 31.5 percent by weight.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A composite structure comprising:
(A) a first layer comprising a styrenated polyester wherein said first layer is a show surface of said composite structure; and
(B) a polyurethane layer comprising the reaction product of;
(i) a resin component comprising a polyol, wherein said polyol comprises a propylene oxide cap of at least 80 percent by weight based on the total weight of said polyol, and
(ii) a stoichiometric excess of polyisocyanate relative to said resin component.

2. A composite structure as set forth in claim 1 wherein said styrenated polyester has a nominal styrene content of at least 35 percent.

3. A composite structure as set forth in claim 1 wherein said styrenated polyester is formed from phthalic acid and an organic compound comprising a plurality of hydroxyl groups.

4. A composite structure as set forth in claim 3 wherein said phthalic acid is further defined as isophthalic acid.

5. A composite structure as set forth in claim 3 wherein said organic compound is further defined as an alcohol.

6. A composite structure as set forth in claim 1 wherein said polyol is formed from an initiator compound comprising at least one of glycerin, trimethylolpropane, pentaerythritol, propylene glycol, and ethylenediamine.

7. A composite structure as set forth in claim 1 wherein said polyol comprises a propylene oxide cap of 100 percent by weight based on the total weight of said polyol.

8. A composite structure as set forth in claim 1 wherein said polyol has a hydroxyl number of at least 35 mg KOH/gm.

9. A composite structure as set forth in claim 8 wherein said polyol has a hydroxyl number of from 200 to 810 mg KOH/gm.

10. A composite structure as set forth in claim 1 wherein said polyol has a nominal functionality of at least 2.5.

11. A composite structure as set forth in claim 1 wherein said polyol is further defined as a plurality of polyols having a hydroxyl number of at least 35 mg KOH/gm and a nominal functionality of at least 2.5.

12. A composite structure as set forth in claim 11 wherein an average hydroxyl number of said polyols in said plurality is from 310 to 410 mg KOH/gm.

13. A composite structure a set forth in claim 11 wherein said plurality of polyols comprises a pentaerythritol and propylene glycol initiated polyether polyol having a hydroxyl number of from 400 to 500 mg KOH/gm and a nominal functionality of from 3 to 4, and a trimethylolpropane initiated polyether polyol having a hydroxyl number of from 200 to 300 mg KOH/gm and a nominal functionality of from 2.3 to 3.5.

14. A composite structure as set forth in claim 13 wherein said polyols comprise a propylene oxide cap of 100 percent by weight based on the total weight of said polyol.

15. A composite structure as set forth in claim 11 wherein said plurality of polyols comprises a glycerin initiated polyether polyol having a hydroxyl number of from 350 to 450 mg KOH/gm and a nominal functionality of from 2.5 to 3.5, and a glycerin initiated polyether polyol having a hydroxyl number of from 180 to 280 mg KOH/gm and a nominal functionality of from 2.5 to 3.5.

16. A composite structure as set forth in claim 15 wherein said polyols comprise a propylene oxide cap of 100 percent by weight based on the total weight of said polyol.

17. A composite structure as set forth in claim 11 wherein said plurality of polyols comprises a ethylenediamine initiated polyether polyol having a hydroxy number of from 710 to 810 mg KOH/gm and a nominal functionality of from 3.5 to 4.5, and a trimethylolpropane initiated polether polyol having a hydroxyl number of from 20 to 100 mg KOH/gm and a nominal functionality of from 2.0 to 3.0.

18. A composite structure as set forth in claim 1 wherein said polyisocyanate is further defined as polymeric diphenylmethane diisocyanate.

19. A composite structure as set forth in claim 1 wherein said polyisocyanate is further defined as a plurality of polyisocyanates

20. A composite structure as set forth in claim 1 wherein said polyisocyanate has a nominal isocyanate functionality of from 2 to 3.

21. A composite structure as set forth in claim 1 wherein said polyisocyanate has a NCO content of from 20 to 35 (29.5 to 23.0 to 31.5) percent by weight based on the total weight of said polyisocyanate.

22. A composite structure as set forth in claim 1 the volume ratio of said polyisocyanate to said resin component is from 1.1:1 to 3:1.

23. A composite structure as set forth in claim 1 wherein said polyol is present in said resin component in an amount from 55 to 99 percent by weight based on the total weight of said resin component.

24. A composite structure as set forth in claim 1 wherein said resin component further comprises the reaction product of a catalyst.

25. A composite structure as set forth in claim 24 wherein said catalyst comprises at least one of an amine-based catalyst and a tin-based catalyst.

26. A composite structure as set forth in claim 24 wherein said catalyst comprises at least one of triethylenediamine, 1-methyl imidazole, and dimethylbis[(1-oxoneodecyl)oxy]-stannane.

27. A composite structure as set forth in claim 24 wherein said catalyst is present in said resin component in an amount from 0.01 to 0.04 percent by weight based on the total weight of said resin component.

28. A composite structure as set forth in claim 1 wherein said resin component further comprises at least one additive selected from the group consisting of surfactants, flame retardants, fillers, water scavengers, anti-foam agents, surfactants, UV performance enhancers, hindered amine light stabilizers, pigments, thixotropic agents, chain extenders, and combinations thereof.

29. A composite structure as set forth in claim 1 wherein said resin component further comprises an indicating dye for indicating thorough mixing between said polyisocyanate and said resin component.

30. A composite structure as set forth in claim 1 having a heat distortion temperature of from 175° F. to 300° F.

31. A composite structure as set forth in claim 1 having a gel time of from 3 to 20 minutes.
